(19) United States
(12) Patent Application Publication
(10) Pub. No.: US 2025/0162578 A1
(43) Pub. Date: May 22, 2025

(54) ROAD MAPPING FRAMEWORK

(71) Applicant: WAABI Innovation Inc., Toronto (CA)

(72) Inventors: Evan ZHENG, Waterloo (CA); Namdar HOMAYOUNFAR, Toronto (CA); Justin LIANG, Vancouver (CA); Raquel URTASUN, Toronto (CA)

(73) Assignee: WAABI Innovation Inc., Toronto (CA)

(21) Appl. No.: 18/949,302

(22) Filed: Nov. 15, 2024

Related U.S. Application Data
(60) Provisional application No. 63/600,639, filed on Nov. 17, 2023.

(51) Int. Cl. B60W 30/12; G06V 10/77; G06V 20/56

(52) U.S. Cl. CPC B60W 30/12; G06V 10/7715; G06V 20/588

(57) ABSTRACT

A method implements a road mapping framework. The method includes executing an extraction model to generate multiple lane features from a lane image. The method further includes executing a coarse model to generate multiple coarse boundary embeddings and a coarse lane graph from the lane features and multiple prior boundary embeddings using a transformer decoder. The prior boundary embeddings is generated from a prior lane graph. The method further includes executing a refinement model to update the prior lane graph with a refined lane graph to form an updated lane graph. The refined lane graph is generated from multiple refined boundary embeddings that is output from a transformer encoder. The transformer encoder generates the refined boundary embeddings from the coarse boundary embeddings combined with multiple point embeddings corresponding to the coarse boundary embeddings.

### CROSS REFERENCE TO RELATED APPLICATIONS

This application claims benefit to U.S. Provisional Application 63/600,639, filed Nov. 17, 2023, which is hereby incorporated by reference herein.

### BACKGROUND

High-definition (HD) maps are a major component of modern autonomous vehicle (AV) systems. High-definition maps are leveraged on-board as a prior for perception and motion forecasting, motion planning, and lightweight localization. High-definition maps are also used off-board for simulation purposes, to enable intelligent actors to drive naturalistically and respect traffic rules. A component of these high-definition maps are lane graphs, which contain very precise geometric and semantic information about the roads such as lanes and shoulders, as well as the traffic rules governing the interaction of these elements and the road users. For example, lanes define the driving corridors for a road user and the marking and color of lane boundaries specify whether lane changes are allowed.

While lane graphs are a source of knowledge to increase the safety of self-driving vehicles, current approaches to create lane graphs are not scalable. High-definition map providers may rely on hundreds of annotators meticulously drawing polyline representations of the lane graphs. The process may consume significant resources to create high-definition maps. In the US alone, there are about 253,832 km of highway roads which is about six times the equatorial circumference of Earth.

Automation may be used to reduce the resources used to build lane graphs. Challenges include producing highly accurate geometries and accurate connectivity of these geometries. Many previous systems focused on the task of online lane graph extraction where an autonomous vehicle-centered lane graph is obtained as needed without demonstrating very high accuracy or accurate connectivity about the global coherence of the lane graph for large areas. Some systems attempt to extend these methods to an offline setting but either have long inference times as the methods are autoregressive or do not demonstrate the high precision and connectivity requirements of an offline lane graph for large areas. Both online and offline approaches to automated lane graph generation suffer from long inference times with the models used to generate the lane graphs.

### SUMMARY

In general, in one or more aspects, the disclosure relates to a method of a road mapping framework. The method includes executing an extraction model to generate multiple lane features from a lane image. The method further includes executing a coarse model to generate multiple coarse boundary embeddings and a coarse lane graph from the lane features and multiple prior boundary embeddings using a transformer decoder. The prior boundary embeddings are generated from a prior lane graph. The method further includes executing a refinement model to update the prior lane graph with a refined lane graph to form an updated lane graph. The refined lane graph is generated from multiple refined boundary embeddings that is output from a transformer encoder. The transformer encoder generates the refined boundary embeddings from the coarse boundary embeddings combined with multiple point embeddings corresponding to the coarse boundary embeddings.

In general, in one or more aspects, the disclosure relates to a system that includes at least one processor and an application that executes on the at least one processor. Executing the application performs executing an extraction model to generate multiple lane features from a lane image. Executing the application further performs executing a coarse model to generate multiple coarse boundary embeddings and a coarse lane graph from the lane features and multiple prior boundary embeddings using a transformer decoder. The prior boundary embeddings are generated from a prior lane graph. Executing the application further performs executing a refinement model to update the prior lane graph with a refined lane graph to form an updated lane graph. The refined lane graph is generated from multiple refined boundary embeddings output from a transformer encoder. The transformer encoder generates the refined boundary embeddings from the coarse boundary embeddings combined with multiple point embeddings corresponding to the coarse boundary embeddings.

In general, in one or more aspects, the disclosure relates to a non-transitory computer readable medium including instructions executable by at least one processor. Executing the instructions performs executing an extraction model to generate lane features from a lane image. Executing the instructions further performs executing a coarse model to generate multiple coarse boundary embeddings and a coarse lane graph from the lane features and multiple prior boundary embeddings using a transformer decoder. The prior boundary embeddings are generated from a prior lane graph. Executing the instructions further performs executing a refinement model to update the prior lane graph with a refined lane graph to form an updated lane graph. The refined lane graph is generated from multiple refined boundary embeddings output from a transformer encoder. The transformer encoder generates the refined boundary embeddings from the coarse boundary embeddings combined with multiple point embeddings corresponding to the coarse boundary embeddings.

Other aspects of one or more embodiments may be apparent from the following description and the appended claims.

### BRIEF DESCRIPTION OF DRAWINGS

FIG. 1 and FIG. 2 show diagrams of autonomous training and testing systems in accordance with the disclosure.

FIG. 3 shows a diagram of a system in accordance with the disclosure.

FIG. 4 shows a flowchart of a method in accordance with the disclosure.

FIG. 5, FIG. 6, and FIG. 7 show examples of systems and methods in accordance with the disclosure.

FIG. 8A and FIG. 8B show a computing system in accordance with one or more embodiments of the invention.

Similar elements in the various figures are denoted by similar names and reference numerals. The features and elements described in one figure may extend to similarly named features and elements in different figures.

### DETAILED DESCRIPTION

One or more embodiments is directed to a resource-efficient approach is disclosed to build high precision lane graphs for large stretches of roadways. Towards this goal, a transformer-based model traverses the roadway in a sliding window manner and outputs a global lane graph in a coarse-to-fine fashion. The global lane graph may be precise and topologically correct. The inference process may “slide” across the images and “draw” a precise lane graph for a small region at a time while maintaining connectivity to the previous annotations. In the coarse stage of a traversal step, a detection transformer (DETR)-like transformer decoder outputs a coarse lane graph for a new section of the roadway conditioned on deep image features and the prior lane graph predicted at previous traversal stages. The prior lane graph guides and encourages the coarse lane graph to be in the continuation of the previous lane boundaries. A coarse stage may obtain coarse lane boundaries in the continuation of the prior lane graph but does not identify lane boundary connectivity within the coarse lane graph or the prior lane graph. In the refinement stage, the coarse lane graph may be refined with a transformer that attends to high-resolution features to increase accuracy from the coarse lane graph and identify connectivity between the coarse lane graph and the prior lane graph. At the end of traversal, a precise and cohesive global lane graph is obtained.

A metric, called the lane graph metric (LGM), may quantify the quality of a lane graph. Geometric correctness and connectivity of a lane graph may be evaluated using different metrics. The lane graph metric may provide an assessment of the inferred lane graph in terms of detection quality, topological correctness, and classification accuracy in one metric. Furthermore, the lane graph metric may be decomposed into submetrics that aid in understanding different aspects of the derived lane graph.

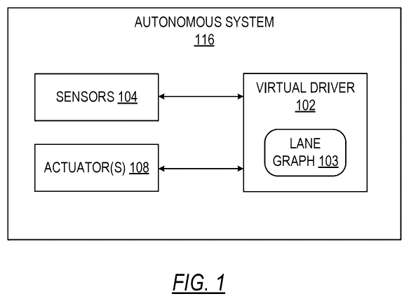

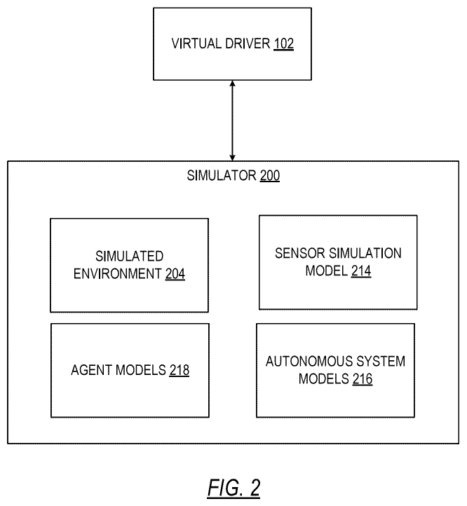

Turning to the Figures, FIG. 1 and FIG. 2 show example diagrams of the autonomous system and virtual driver. Turning to FIG. 1, an autonomous system (116) is a self-driving mode of transportation that does not require a human pilot or human driver to move and react to the real-world environment. The autonomous system (116) may be completely autonomous or semi-autonomous. As a mode of transportation, the autonomous system (116) is contained in a housing configured to move through a real-world environment. Examples of autonomous systems include self-driving vehicles (e.g., self-driving trucks and cars), drones, airplanes, robots, etc.

The autonomous system (116) includes a virtual driver (102) that is the decision-making portion of the autonomous system (116). The virtual driver (102) is an artificial intelligence system that learns how to interact in the real world and interacts accordingly. The virtual driver (102) is the software executing on a processor that makes decisions and causes the autonomous system (116) to interact with the real-world including moving, signaling, and stopping or maintaining a current state. Specifically, the virtual driver (102) is decision-making software that executes on hardware (not shown). The hardware may include a hardware processor, memory or other storage device, and one or more interfaces. A hardware processor is any hardware processing unit that is configured to process computer readable program code and perform the operations set forth in the computer readable program code.

A real-world environment is the portion of the real world through which the autonomous system (116), when trained, is designed to move. Thus, the real-world environment may include concrete and land, construction, and other objects in a geographic region along with agents. The agents are the other agents in the real-world environment that are capable of moving through the real-world environment. Agents may have independent decision-making functionality. The independent decision-making functionality of the agent may dictate how the agent moves through the environment and may be based on visual or tactile cues from the real-world environment. For example, agents may include other autonomous and non-autonomous transportation systems (e.g., other vehicles, bicyclists, robots), pedestrians, animals, etc.

In the real world, the geographic region is an actual region within the real world that surrounds the autonomous system. Namely, from the perspective of the virtual driver, the geographic region is the region through which the autonomous system moves. The geographic region includes agents and map elements that are located in the real world. Namely, the agents and map elements each have a physical location in the geographic region that denotes a place in which the corresponding agent or map element is located. The map elements are stationary in the geographic region, whereas the agents may be stationary or nonstationary in the geographic region. The map elements are the elements shown in a map (e.g., road map, traffic map, etc.) or derived from a map of the geographic region.

The map of the geographic region may be a high-definition map that includes the lane graph (103). The lane graph (103) may include nodes and edges, which together form a representation of the structure of lanes of a roadway. Nodes in the lane graph may correspond to points along the boundaries of detected lanes. Each node may represent a distinct point on a lane boundary, identified from an image. The nodes may contain information such as spatial coordinates or other relevant attributes that define the position and characteristics of a point on the lane boundary. Edges in the lane graph may identify relationships between the nodes. An edge may connect two or more nodes and indicate a direct connection or association between those points on the lane boundary. Edges may encode information about relational aspects between different points on the lane structure, including the continuity of lane boundaries, the direction of a lane, merging of lanes, etc. The structure of the lane graph enables the automated systems to maintain and update complex lane geometries, including curved lanes, intersections, or other non-linear road structures.

The real-world environment changes as the autonomous system (116) moves through the real-world environment. For example, the geographic region may change and the agents may move positions, including new agents being added and existing agents leaving.

In order to interact with the real-world environment, the autonomous system (116) includes various types of sensors (104), such as light detection and ranging (LiDAR) sensors amongst other types, which are used to obtain measurements of the real-world environment, and cameras that capture images from the real-world environment. The autonomous system (116) may include other types of sensors as well. The sensors (104) provide input to the virtual driver (102).

In addition to sensors (104), the autonomous system (116) includes one or more actuators (108). An actuator is hardware and/or software that is configured to control one or more physical parts of the autonomous system based on a control signal from the virtual driver (102). In one or more embodiments, the control signal specifies an action for the autonomous system (e.g., turn on the blinker, apply brakes by a defined amount, apply accelerator by a defined amount, turn the steering wheel or tires by a defined amount, etc.). The actuator(s) (108) are configured to implement the action. In one or more embodiments, the control signal may specify a new state of the autonomous system and the actuator may be configured to implement the new state to cause the autonomous system to be in the new state. For example, the control signal may specify that the autonomous system should turn by a certain amount while accelerating at a predefined rate, while the actuator determines and causes the wheel movements and the amount of acceleration on the accelerator to achieve a certain amount of turn and acceleration rate.

The testing and training of the virtual driver (102) of the autonomous systems in the real-world environment may be unsafe because of the accidents that an untrained virtual driver can cause. Thus, as shown in FIG. 2, a simulator (200) is configured to train and test a virtual driver (102) of an autonomous system. For example, the simulator may be a unified, modular, mixed-reality, closed-loop simulator for autonomous systems. The simulator (200) is a configurable simulation framework that enables not only the evaluation of different autonomy components of the virtual driver (102) in isolation, but also as a complete system in a closed-loop manner. The simulator reconstructs “digital twins” of real-world scenarios automatically, enabling accurate evaluation of the virtual driver at scale. The simulator (200) creates the simulated environment (204) which is a virtual world in which the virtual driver (102) is a player in the virtual world. The simulated environment (204) is a simulation of a real-world environment, which may or may not be in actual existence, in which the autonomous system is designed to move. As such, the simulated environment (204) includes a simulation of the objects (i.e., simulated objects or agents) and background in the real world, including the natural objects, construction, buildings and roads, obstacles, as well as other autonomous and non-autonomous objects. The simulated environment simulates the environmental conditions within which the autonomous system may be deployed. The simulated objects may include both stationary and nonstationary objects. Nonstationary objects are agents in the real-world environment.

In the simulated environment, the geographic region is a realistic representation of a real-world region that may or may not be in actual existence. Namely, from the perspective of the virtual driver, the geographic region appears the same as if the geographic region were in existence if the geographic region does not actually exist, or the same as the actual geographic region present in the real world. The geographic region in the simulated environment includes virtual agents and virtual map elements that would be actual agents and actual map elements in the real world. Namely, the virtual agents and virtual map elements each have a physical location in the geographic region that denotes an exact spot or place in which the corresponding agent or map element is located. The map elements are stationary in the geographic region, whereas the agents may be stationary or nonstationary in the geographic region. As with the real world, a map exists of the geographic region that specifies the physical locations of the map elements.

The simulator (200) includes the autonomous system models (216), sensor simulation models (214), and agent models (218). The autonomous system models (216) are detailed models of the autonomous system in which the virtual driver (102) will execute. The autonomous system models (216) include models, geometry, physical parameters (e.g., mass distribution, points of significance), engine parameters, sensor locations and type, firing pattern of the sensors, information about the hardware on which the virtual driver executes (e.g., processor power, amount of memory, and other hardware information), and other information about the autonomous system. The various parameters of the autonomous system model may be configurable by the user or another system.

The autonomous system models (216) include an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous systems. The interface between the virtual driver (102) and the simulator (200) may match the interface between the virtual driver (102) and the autonomous system in the real world. Thus, to the virtual driver (102), the simulator simulates the experience of the virtual driver within the autonomous system in the real world.

In one or more embodiments, the sensor simulation model (214) models, in the simulated environment, active and passive sensor inputs. The sensor simulation models (114) are configured to simulate the sensor observations of the surrounding scene in the simulated environment (204) at each time step according to the sensor configuration on the vehicle platform. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors and the measurements being simulated based on the simulated environment, based on the simulated position of the sensor(s), within the simulated environment.

Agent models (218) may each represent an agent in a scenario. An agent is a sentient being that has an independent decision-making process. Namely, in a real world, the agent may be an animate being (e.g., person or animal) that makes a decision based on an environment. The agent makes active movement rather than or in addition to passive movement. An agent model, or an instance of an actor model may exist for each agent in a scenario. The agent model is a model of the agent. If the agent is in a mode of transportation, then the agent model includes the model of transportation in which the agent is located. For example, actor models may represent pedestrians, children, vehicles being driven by drivers, pets, bicycles, and other types of actors.

The training of the virtual driver may be performed by using log data. Log data from the real world is used to generate an initial virtual world. The log data may be used to define, at least in part, which asset and actor models are used in an initial positioning of assets. The simulator executes a sensor simulation model that may use beamforming and other techniques to replicate the view to the sensors of the autonomous system.

The simulated sensor output is passed to the virtual driver. The virtual driver executes based on the simulated sensor output to generate actuation actions. The actuation actions define how the virtual driver controls the autonomous system. For example, for a self-driving vehicle, the actuation actions may be the amount of acceleration, movement of the steering, triggering of a turn signal, etc. From the actuation actions, the autonomous system state in the simulated environment is updated. Further, actor actions in the simulated environment are modeled based on the simulated environment state. Concurrently with the virtual driver model, the actor models and asset models are executed on the simulated environment state to determine an update for each of the assets and actors in the simulated environment. The actors' actions may use the previous output of the evaluator to test the virtual driver.

The updated simulated environment state is updated according to the actors' actions and the autonomous system state. The updated simulated environment includes the change in positions of the actors and the autonomous system. The process can repeat for a next time step. Because the models execute independently of the real world, the update may reflect a deviation from the real world. Thus, the autonomous system is tested with new scenarios.

One or more embodiments may be used outside of autonomous systems. For example, embodiments may create maps for gaming environments, or any other geospatial information system such as a mapping program.

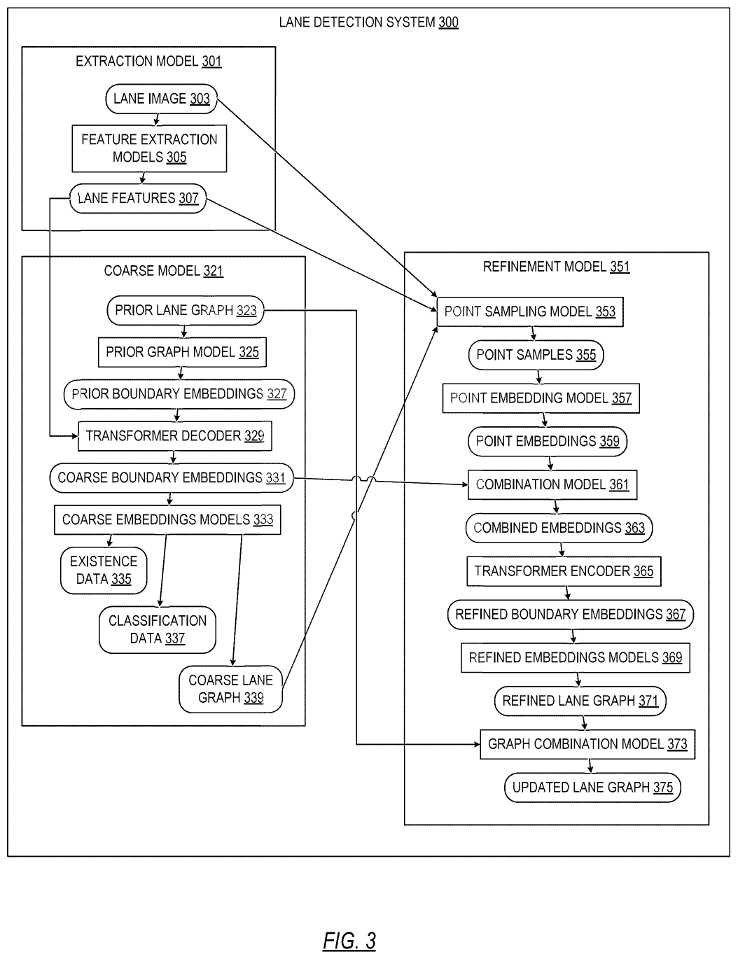

Turning to FIG. 3, the lane detection system (300) is a computing system that executes one or more programs to detect and analyze lane structures from images. The lane detection system (300) processes input images to generate detailed representations of lane boundaries and relationships. The lane detection system (300) incorporates multiple stages of processing, including feature extraction, coarse lane detection, and refinement, to produce accurate and up-to-date lane graphs for use in autonomous systems for navigation. The lane detection system (300) utilizes various machine learning models and techniques throughout the detection process. The models used may include residual networks, feature pyramid networks, transformer architectures, multilayer perceptrons, etc. The models of the lane detection system (300) effectively handle complex images of road scenes and produce improved lane detection results. The lane detection system (300) maintains and updates lane information over time through the use of prior and updated lane graphs. The system begins each iteration with the prior lane graph (323), which represents the previously detected lane structure. After processing the current lane image (303), the system generates the updated lane graph (375), which becomes the prior lane graph (323) for the next iteration. This approach allows the lane detection system (300) to maintain continuity and improve accuracy over successive iterations.

The extraction model (301) may perform initial processing for lane detection. The extraction model (301) takes the lane image as input and generates lane features as output. The extraction model (301) may include down sampling of the input image (e.g., the lane image (303)) and utilize the feature extraction models (305), which may include a residual network and a feature pyramid network, to process the image data (e.g., the lane image (303)). The extraction model identifies and extracts relevant lane information from raw image data, which is subsequently processed by the coarse model (321) and refinement model (351).

The lane image (303) is an input to the lane detection process. The lane image (303) is a visual representation of a road scene, that may have been captured by sensors (camera sensors, LiDAR sensors, etc.) mounted on an autonomous system. The lane image (303) may be one of multiple images cropped from a larger image that each have a fixed resolution for processing by the lane detection system. Different systems may use different sizes. The image data may be stored in a common image file format such as JPEG, PNG, or raw image data for faster processing. The lane image (303) may be stored as a multi-dimensional array of pixel values, which may be in a format such as RGB (Red, Green, Blue) or grayscale. Each pixel in the image may be represented by one or more numerical values corresponding to color or intensity. For a color image, the representation may be a three-dimensional array where the first two dimensions represent the width and height of the image, and the third dimension represents the color channels (e.g., red, green, and blue). The lane image (303) may include raw visual data of road markings, lane boundaries, and other relevant features for lane detection. The lane image provides the raw data from which subsequent lane detection and analysis is derived. The quality and clarity of lane image (303) may impact the accuracy of the lane detection process.

The feature extraction models (305) are a set of machine learning models used within the extraction model (301) to process the lane image (303). The feature extraction models (305) may include a residual network model, a feature pyramid network model, etc. The feature extraction models (305) identify and extract relevant features from the image data, such as lane markings and boundaries. The feature extraction models (305) transform raw image data into a more structured and meaningful representation (lane features) that may be effectively used by subsequent stages of the lane detection process.

The lane features (307) are the output of the feature extraction models (305) and that may be input to the coarse model (321). The lane features (307) may include a feature map with multiple channels, including a channel for identifying lane markings within the image. The lane features (307) represent a structured and condensed form of the relevant information extracted from the original lane image (303). The lane features (307) encapsulate the lane-related information in a format that is suitable for further processing by the coarse model (321) and subsequent stages of the lane detection system.

The coarse model (321) is a component of the lane detection system (300) that processes the lane features (307) generated by the extraction model (301). The coarse model (321) generates the coarse boundary embeddings (331) and the coarse lane graph (339) from the lane features (307) and the prior boundary embeddings (327). The output of the coarse model (321) may not be as precise as the output of the refinement model (351), e.g., the coarse lane graph (339) may identify lane boundaries with less precision than the refined lane graph (371). The coarse model (321) may utilize the transformer decoder (329) to perform these operations to generate an initial representation of lane boundaries and structure.

The prior lane graph (323) is a data structure that represents the detected lane information from a previous iteration of the lane detection process. The prior lane graph (323) may be a subset of a larger lane graph that is relevant to the lane image (303). The prior lane graph (323) serves as a starting point for the current iteration of lane detection, providing historical context that may be refined and updated based on new information from the lane image (303).

The prior graph model (325) is a program that processes the prior lane graph (323) to generate prior boundary embeddings (327). The prior graph model (325) may be implemented as a neural network that may include a multilayer perceptron. The prior graph model (325) utilizes learned weights and parameters to process the prior lane graph (323) and generate the prior boundary embeddings (327). The weights and parameters may be trained to extract relevant features from the graph structure, transforming the node and edge information of the prior lane graph (323) into a continuous vector representation in the form of prior boundary embeddings (327). The weights and parameters of the prior graph model (325) may be optimized through training to effectively capture the spatial and relational information encoded in the prior lane graph (323) and are used by the prior graph model (325) to transform the structural information contained in the prior lane graph (323) into a format that may be used by the transformer decoder (329) within the coarse model (321).

The prior boundary embeddings (327) are the output of the prior graph model (325), derived from the prior lane graph (323). The prior boundary embeddings (327) represent the lane boundary information from the previous iteration in a format that may be processed by the transformer decoder (329). The prior boundary embeddings (327) serve as query parameters for the transformer decoder (329), allowing the coarse model (321) to integrate historical lane information with new lane features (307). The lane detection system (300) uses boundary embeddings to identify boundaries between lanes. One boundary embedding may be a vector of continuous scalar values (e.g., 60 values) that represents one lane boundary that may be identified from a lane image (e.g., from the lane image (303)).

The transformer decoder (329) is a component within the coarse model (321) that generates the coarse boundary embeddings (331) from the prior boundary embeddings (327) and the lane features (307). The transformer decoder (329) may utilize cross-attention mechanisms, where the prior boundary embeddings (327) serve as query parameters, and the lane features (307) serve as key and value parameters. The transformer decoder (329) processes inputs within a context window, which defines the range of information considered for each decoding step. A boundary embedding (e.g., one of the prior boundary embeddings (327)) may be treated as a token within the context window, representing a discrete unit of lane boundary information. The transformer decoder (329) enables the coarse model (321) to effectively combine prior lane information with newly extracted features, producing updated representations of lane boundaries in the coarse boundary embeddings (331).

The coarse boundary embeddings (331) are the output of the transformer decoder (329) within the coarse model (321). The coarse boundary embeddings (331) represent updated lane boundary information that incorporates both prior knowledge from the prior boundary embeddings (327) and new information from the lane features (307). The coarse boundary embeddings (331) serve as input to the coarse embeddings models (333) for further processing and refinement of lane detection results.

The coarse embeddings models (333) are a set of machine learning models within the coarse model (321) that process the coarse boundary embeddings (331). The coarse embeddings models (333) may be neural networks implemented as multilayer perceptrons, which are feedforward neural networks with multiple layers of nodes. The coarse embeddings models (333) generate the coarse lane graph (339), the existence data (335), and the classification data (337) from the coarse boundary embeddings (331). One of the course embeddings models (333) may generate the existence data (335), one of the course embeddings models (333) may generate the classification data (337), and one of the course embeddings models (333) may generate the coarse lane graph (339). The coarse embeddings models (333) transform the continuous vector representations of lane boundaries into structured lane information and associated metadata.

The existence data (335) is output generated by the coarse embeddings models (333) based on the coarse boundary embeddings (331). The existence data (335) may indicate the presence or absence of lane boundaries at specific locations within the lane image (303). The existence data (335) provides information about the likelihood of lane boundaries existing at particular points, which may be used in subsequent refinement steps of the lane detection process.

The classification data (337) is another output produced by the coarse embeddings models (333) from the coarse boundary embeddings (331). The classification data (337) may contain information about the types or characteristics of detected lane boundaries, such as solid lines, dashed lines, or other lane markings. The classification data (337) enhances the lane detection results by providing additional context about the nature of the detected lane boundaries.

The coarse lane graph (339) is a structured representation of lane information generated by the coarse embeddings models (333) from the coarse boundary embeddings (331). The coarse lane graph (339) may include nodes representing points along lane boundaries and edges representing relationships between these points. The coarse lane graph (339) may be an initial estimate of the lane structure, which may be further refined by the refinement model (351) in subsequent stages of the lane detection process.

The refinement model (351) is a component of the lane detection system (300) that processes the outputs from the coarse model (321) to generate a refined lane graph (371). The refinement model (351) may utilize multiple inputs from the extraction model (301) and the course model (321), including the lane image (303), the lane features (307), the prior lane graph (323), the course boundary embeddings (331), and the coarse lane graph (339). The refinement model (351) may utilize various subcomponents including the point sampling model (353), the point embedding model (357), the combination model (361), the transformer encoder (365), the refined embeddings models (369), and the graph combination model (373) to generate more accurate and detailed lane boundary representations.

The point sampling model (353) is a subcomponent of the refinement model (351) that generates the point samples (355) from the lane image (303), the lane features (307), and the coarse lane graph (339). The point sampling model (353) may up sample the lane image (303) and densify the lane boundaries from the coarse lane graph (339) to create a more detailed set of boundary points. The point sampling model (353) samples from the up sampled image and the lane features (307) using the densified boundary points to generate the point samples (355).

The point samples (355) are the output of the point sampling model (353) that are input to the point embedding model (357). A point identifies a location of a lane boundary in a geographic region, and a point sample is a collection of data related to (e.g., near) one of the points. One of the point samples (355) may include a portion of the up sampled image cropped around the location of the point and the features related to the location. The point samples (355) may collectively include information about specific points along the lane boundaries, corresponding to the up sampled image, the lane features (307), and the coarse boundary embeddings (331). The point samples (355) provide a more granular representation of the lane boundaries, allowing for finer refinement of the lane detection results.

The point embedding model (357) is a neural network within the refinement model (351) that processes the point samples (355) to generate point embeddings (359). The point embedding model (357) may be a residual network model that transforms the sampled point data into a continuous vector representation that captures relevant features of each point at the location of the point. The point embedding model (357) is used by the refinement model (351) to include a more detailed and informative representation of the lane structure.

The point embeddings (359) are the output of the point embedding model (357) and represent a refined version of the lane boundary information. One of the point embeddings (359) may correspond to one of the point samples (355). A subset of the point embeddings (359) may correspond to one of the coarse boundary embeddings (331). The point embeddings (359) are inputs to subsequent components of the refinement model (351), such as the transformer encoder (365), to further refine the lane detection results.

The combination model (361) is a component within the refinement model (351) that processes the point embeddings (359) and the coarse boundary embeddings (331). The combination model (361) combines the detailed information from the point embeddings (359) with the broader context provided by the coarse boundary embeddings (331). For each of the coarse boundary embeddings (331), the combination model (361) may use concatenation to combine one of the course boundary embeddings (331) with multiple point embeddings from the point embeddings (359) to generate one of the combined embeddings (363). The combination model (361) generates the combined embeddings (363), which incorporate both fine-grained and coarse-level information about the lane boundaries.

The combined embeddings (363) are the output of the combination model (361) within the refinement model (351). The combined embeddings (363) represent a fusion of the detailed point-level information from the point embeddings (359) and the broader contextual information from the coarse boundary embeddings (331). The combined embeddings (363) provide a comprehensive representation of the lane boundaries that incorporates both fine-grained details and overall structure. The combined embeddings (363) may be input to the transformer encoder (365) for further refinement and processing.

The transformer encoder (365) is a component within the refinement model (351) that processes the combined embeddings (363). The transformer encoder (365) may utilize self-attention mechanisms to analyze and refine the relationships between different parts of the lane boundaries represented in the combined embeddings (363). The transformer encoder (365) operates on a context window, which defines the range of information considered during each encoding step. Within this context window, each combined embedding from the combined embeddings (363) may be treated as a token, representing a discrete unit of lane boundary information. The transformer encoder (365) generates the refined boundary embeddings (367), which represent a further refined and contextualized version of the lane boundary information. The refined boundary embeddings (367) capture complex spatial relationships within the lane structure.

The refined boundary embeddings (367) are the output of the transformer encoder (365) within the refinement model (351). The refined boundary embeddings (367) represent a highly processed and refined version of the lane boundary information, incorporating both detailed point-level features and broader contextual information. The refined boundary embeddings (367) may be input to the refined embeddings models (369). The refined boundary embeddings (367) provide a sophisticated representation of the lane structure that may be used to produce accurate and detailed lane detection results.

The refined embeddings models (369) are a set of machine learning models within the refinement model (351) that process the refined boundary embeddings (367). The refined embeddings models (369) may be implemented as neural networks, such as multilayer perceptrons. The refined embeddings models (369) generate offset data and connectivity data from the refined boundary embeddings (367). The offset data and connectivity data produced by the refined embeddings models (369) are used in combination with boundary points to form the refined lane graph (371). The boundary points are the points that define a lane in the lane image (303). The offset data identifies offsets for the boundary points generated from the coarse lane graph (339) to improve the precision of the boundary points within the refined lane graph (371). The connectivity data is the connections between the boundary points that may form a lane boundary to improve the precision of the data stored in the edges of the refined lane graph (371).

The refined lane graph (371) is a data structure generated by the refinement model (351) that represents an improved, detailed, and accurate representation of the lane structure from the lane image (303). The refined lane graph (371) incorporates the offset data and connectivity data produced by the refined embeddings models (369), combined with boundary points derived from earlier stages of the lane detection process. The refined lane graph (371) may include nodes representing precise locations along lane boundaries and edges representing relationships between these points. The refined lane graph (371) may be an improved, more accurate, and more detailed representation of the lane structure compared to the coarse lane graph (339).

The graph combination model (373) is a component within the refinement model (351) that processes the prior lane graph (323) and the refined lane graph (371). The graph combination model (373) may be implemented as a neural network or a set of rules that determine how to merge information from both graphs. The graph combination model (373) generates the updated lane graph (375) by integrating the prior information from the prior lane graph (323) with the improved and refined information from the refined lane graph (371).

The updated lane graph (375) may be an output of the lane detection system (300), produced by the graph combination model (373). The updated lane graph (375) represents a current representation of the lane structure, incorporating both prior information and refined data. The updated lane graph (375) may be used by autonomous systems for navigation and decision-making purposes. The updated lane graph (375) may become the prior lane graph (323) for the next iteration of the lane detection process to provide continuity and improvement in lane detection over time.

Each of the models utilized within the lane detection system (300) may include one or more machine learning models. The machine learning models may include neural networks and may operate using one or more layers of weights that may be sequentially applied to sets of input data, which may be referred to as input vectors. For each layer of a machine learning model, the weights of the layer may be multiplied by the input vector to generate a collection of products, which may then be summed to generate an output for the layer that may be fed, as input data, to a next layer within the machine learning model. Different architectures may be used. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for residual neural networks, feature pyramid neural networks, recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc.

The machine learning models may be trained by inputting training data to a machine learning model to generate training outputs that are compared to expected outputs. For supervised training, the expected outputs may be labels associated with a given input. For unsupervised learning, the expected outputs may be previous outputs from the machine learning model. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

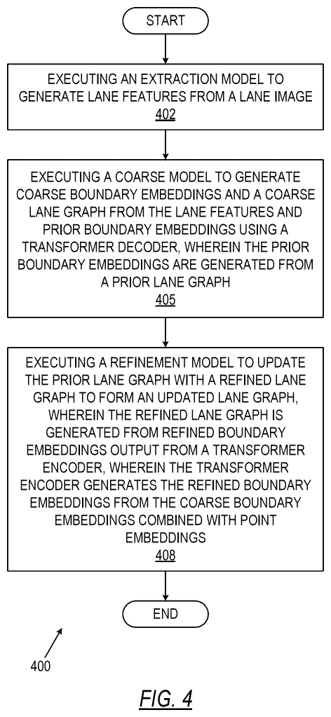

FIG. 4 shows a flowchart of a method to detect lane boundaries from images. The method of FIG. 4 may be implemented using the components of FIG. 1, FIG. 4, and FIG. 3, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 4, the process (400) may be part of the application of a lane detection system that identifies lane boundaries from lane images. The process (400) may include multiple steps (e.g., steps (402) through (408)) that may execute on the components described in the other figures, including those of FIG. 1.

Step (402) includes executing an extraction model to generate lane features from a lane image. The extraction model may be a neural network trained on a dataset of labeled lane images. The model may analyze pixel patterns and intensity values in the input lane image to identify features characteristic of lane markings, road edges, and other relevant lane elements.

Executing the extraction model may include down sampling the lane image to generate a down sampled image. Down sampling may reduce the resolution of the original lane image, typically by a factor of 2 or 4, to decrease computational requirements. Common down sampling techniques include max pooling or average pooling over pixel neighborhoods.

Executing the extraction model may include executing a set of feature extraction models to generate the lane features from a down sampled image. The set of feature extraction models may comprise multiple convolutional neural networks, each designed to extract different types of lane features at various scales. The models may operate in parallel or in sequence on the down sampled image.

The set of feature extraction models may include a residual network model and a feature pyramid network model. A residual network model may use skip connections between layers to allow gradients to flow more easily through deep networks. A feature pyramid network model may generate multi-scale feature maps to detect lane elements of different sizes.

The lane features may include a feature map with a set of channels. The feature map may be a multi-dimensional array representing detected lane features at different spatial locations in the image. Each channel in the feature map may correspond to a particular type of lane feature or attribute.

The set of channels may include a lane marking channel to identify lane markings within the down sampled image. The lane marking channel may contain high activation values at pixels likely to be part of lane markings based on learned patterns. Additional channels may represent other lane-related features such as road edges, lane direction, or surface type.

Continuing with the process (400), Step (405) includes executing a coarse model to generate coarse boundary embeddings and a coarse lane graph from the lane features and prior boundary embeddings using a transformer decoder. The coarse model may process the extracted lane features along with information from previous frames to produce initial estimates of lane boundaries. The coarse model may be implemented as a neural network with transformer architecture, taking lane features and prior embeddings as inputs.

The prior boundary embeddings are generated from a prior lane graph. The prior lane graph may represent lane structure detected in previous frames or time steps. The prior lane graph may be maintained and updated as new frames are processed, using the graph to generate embeddings for the current frame.

Executing the coarse model may include executing a prior graph model to generate the prior boundary embeddings from the prior lane graph. The prior graph model may convert the graph structure into a format suitable for input to the transformer decoder. The prior graph model may be implemented as a separate neural network component within the larger lane detection system.

The prior graph model may include a multilayer perceptron. The multilayer perceptron may transform node and edge features from the prior lane graph into dense vector representations. The multilayer perceptron may be constructed with multiple fully connected layers and non-linear activation functions.

Executing the coarse model may include executing the transformer decoder to generate the coarse boundary embeddings from the prior boundary embeddings using cross attention between the prior boundary embeddings and the lane features. The transformer decoder may use the attention mechanism to selectively focus on relevant parts of the lane features based on the prior embeddings. The transformer decoder may be implemented with multiple attention and feed-forward layers.

The prior boundary embeddings may be used as query parameters by the transformer decoder. The query parameters may guide the attention mechanism to focus on relevant information. The prior boundary embeddings may be formatted and passed as query inputs to the transformer decoder component.

The lane features may be used as key parameters and value parameters by the transformer decoder. The key and value parameters may provide the information that the attention mechanism selects from and combines. The lane features may be formatted appropriately and provided as key and value inputs to the transformer decoder.

Executing the coarse model may include executing coarse embeddings models to generate the coarse lane graph, existence data, and classification data from the coarse boundary embeddings. The coarse embeddings models may interpret the output of the transformer decoder to produce structured lane information. The coarse embeddings models may be implemented as additional neural network layers or separate model components.

The coarse boundary embeddings may be a subset of decoder output embeddings that do not correspond to the prior boundary embeddings. These embeddings may represent newly detected or updated lane boundary information. The relevant subset of embeddings may be selected and extracted from the full transformer decoder output for further processing.

Continuing with the process (400), Step (408) includes executing a refinement model to update the prior lane graph with a refined lane graph to form an updated lane graph. The refinement model may take the coarse lane graph as input and apply additional processing to improve accuracy and detail. The refinement model may be implemented as a neural network that refines the initial lane boundary estimates.

The refined lane graph is generated from refined boundary embeddings output from a transformer encoder. The transformer encoder may process the coarse boundary information to produce more precise lane boundary representations. The transformer encoder may be constructed with multiple self-attention layers to refine the boundary embeddings.

The transformer encoder generates the refined boundary embeddings from the coarse boundary embeddings combined with point embeddings. The point embeddings may provide local image information to supplement the coarse embeddings. The coarse boundary embeddings and point embeddings may be concatenated or otherwise combined before being passed through the transformer encoder.

Executing the refinement model may include up sampling the lane image to generate an up sampled image. Up sampling may increase the resolution of the image to allow for more precise boundary localization. Up sampling may be performed using techniques such as bilinear interpolation or transposed convolutions.

Executing the refinement model may include densifying lane boundaries from the coarse lane graph to form boundary points corresponding to the lane boundaries for the lane image. Densification may increase the number of points representing each lane boundary for improved detail. Additional points may be interpolated along the coarse boundary curves to create denser representations.

Executing the refinement model may include sampling from the up sampled image and from the lane features using the boundary points to generate point samples. Sampling may extract relevant local image and feature information around each boundary point. The boundary point coordinates may be used to select corresponding regions in the up sampled image and lane feature maps for sampling.

The point samples may include a point sample corresponding to a boundary point of the boundary points, to a lane boundary of the lane boundaries, and to a coarse boundary embedding of the coarse boundary embeddings. Each point sample may contain multi-modal information about a specific location on a lane boundary. The point samples may be organized into a structured format, such as a list or array, for further processing.

Executing the refinement model may include executing a point embedding model to generate point embeddings from the point samples. The point embedding model may transform the raw point samples into a learned representation suitable for the transformer encoder. The point embedding model may be implemented as a small neural network, such as a multilayer perceptron, that processes each point sample individually.

The point embeddings may include a point embedding corresponding to a point sample and corresponding to the coarse boundary embedding. Each point embedding may capture local information about a specific boundary location while maintaining a connection to the coarse-level embedding. A fixed-size embedding vector may be generated for each point sample, with the embedding dimensionality matching that of the coarse boundary embeddings.

Executing the refinement model may include executing the transformer encoder to generate the refined boundary embeddings from the coarse boundary embeddings combined with point embeddings using self attention. The transformer encoder may process the combined embeddings through multiple layers of self-attention and feed-forward operations. Self-attention mechanisms may allow each embedding to attend to all other embeddings, enabling the model to capture complex relationships between different parts of the lane boundaries. The refined boundary embeddings may represent more accurate and detailed lane boundary information compared to the coarse embeddings.

Executing the refinement model may include executing refined embeddings models to generate offset data and connectivity data. The refined embeddings models may be implemented as neural networks that interpret the refined boundary embeddings. Offset data may represent fine-grained adjustments to the boundary point positions. Connectivity data may indicate how boundary points should be connected to form continuous lane boundaries. Multiple refined embeddings models may be used, each specialized for generating different types of output data.

The offset data and connectivity data may be combined with boundary points to form the refined lane graph. The combination process may involve applying the offsets to adjust boundary point coordinates and using the connectivity data to establish edges between nodes in the graph. The resulting refined lane graph may represent a more accurate and detailed version of the lane structure compared to the coarse lane graph.

Executing the refinement model may include executing a graph combination model to generate the updated lane graph from the prior lane graph and the refined lane graph. The graph combination model may be designed to merge information from both graphs, potentially resolving conflicts and incorporating new detections while maintaining temporal consistency. Various graph merging algorithms or neural network approaches may be employed to perform the combination effectively.

The process (400) may include loading the refined lane graph to an autonomous system. The loading process may involve transferring the graph data to the memory or processing units of the autonomous system. Data formats and communication protocols compatible with the autonomous system architecture may be used to facilitate efficient loading and subsequent utilization of the lane graph information.

The autonomous system may execute a set of maneuvers to remain in a lane identified by the refined lane graph. These maneuvers may include steering adjustments, speed control, and path planning based on the detected lane boundaries. The refined lane graph may be used as input to the autonomous system decision-making and control algorithms, enabling the system to navigate safely within the identified lane.

The refined lane graph may include a node corresponding to a point of a boundary of a lane identified from the lane image and an edge corresponding to a relationship between the node and a different node. Nodes in the graph may represent specific points along detected lane boundaries, storing information such as spatial coordinates and feature attributes. Edges may encode the topological structure of the lane boundaries, indicating how boundary points are connected to form continuous lines or curves. Additional properties may be associated with nodes and edges to represent various characteristics of the detected lane structure.

The process (400) may include training the coarse model using a loss function. A loss function may be defined to measure the discrepancy between the predictions of the coarse model and ground truth lane annotations. The loss may incorporate terms for boundary localization accuracy, existence probability, and lane marking classification. The extraction model may be trained with the coarse model. During training, the parameters of the coarse model may be iteratively updated to minimize the loss value. Gradient descent techniques may be applied to optimize the model parameters based on batches of training examples. The training process may involve multiple epochs, where the entire dataset is processed repeatedly to refine the performance of the model.

The process (400) may include training a combination of the coarse model and the refinement model using a lane graph metric. The lane graph metric may assess the overall quality of the predicted lane graphs by comparing them to ground-truth annotations. The metric may consider factors such as detection accuracy, topological correctness, and classification performance. Joint training of two or more of the extraction model, the coarse model, and the refinement model may allow for end-to-end optimization of the lane detection pipeline. The training procedure may alternate between updating one or more of the extraction model, the coarse model, and the refinement model, or may update each model simultaneously using a combined loss function with backpropagation. Hyperparameters such as learning rates and loss weighting factors may be tuned to balance the contributions of different components during training.

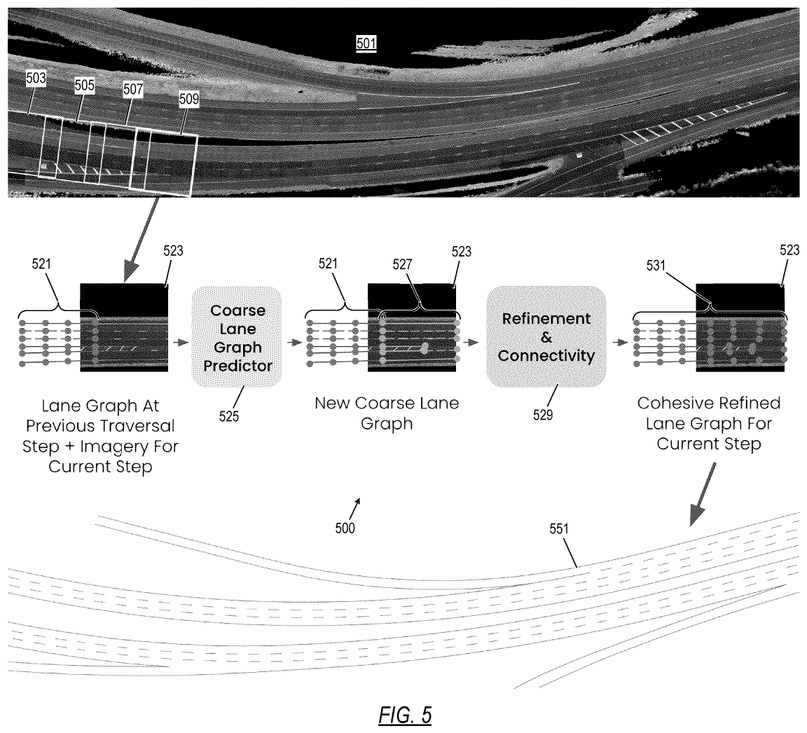

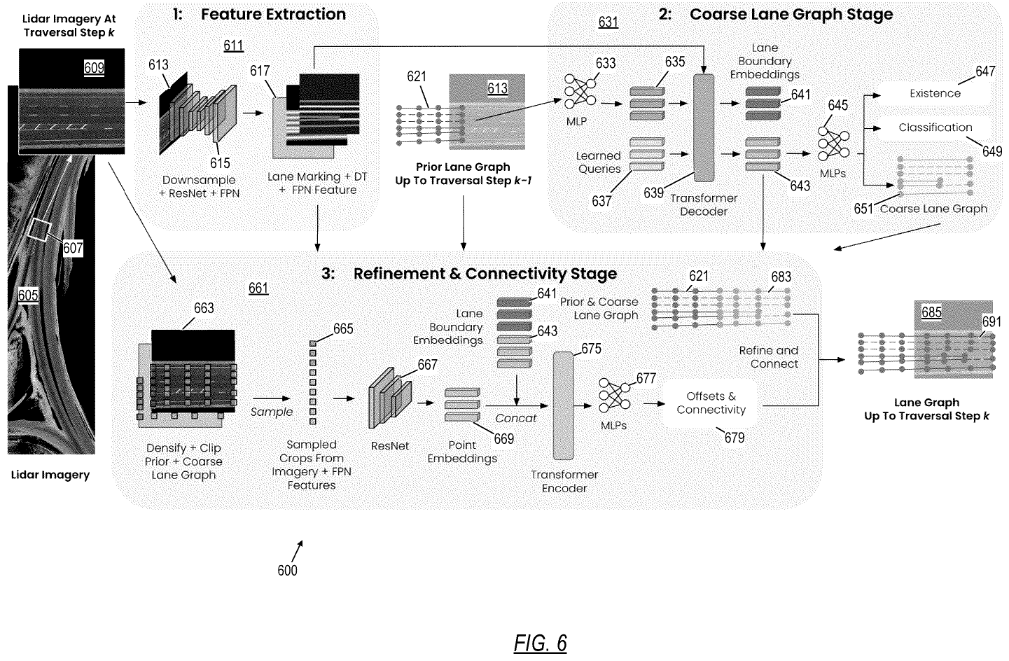

Turning to FIG. 5, the model (500) processes the image (501) (which may also be referred to as a basemap). The image (501) visually depicts lane data of a roadway. The image may be cropped into the poses (503), (505), (507), and (509), which may overlap. The pose (509) may correspond to the image (523), which is input with the prior lane graph (521) to the coarse model (525) of the model (500). The coarse model (525) is a part of the model (500) that does coarse lane graph prediction to generate the course lane graph (527), which may extend the prior lane graph (521) and be relative to the image (523). The prior lane graph (521), the course lane graph (527), and the image (523) may be input to the refinement model (529) of the model (500). The refinement model (529) refines and connects the coarse lane graph (527) to form the refined lane graph (531), which is relative to the image (523). The refined lane graph (531) may form a portion of the lane graph (551) that corresponds to the cropped portion (509) of the image (501).

In the example of FIG. 5 and FIG. 6, the roadways are highways. The input may be LiDAR or other imagery for a large stretch of highway. The models use an iterative, coarse-to-fine strategy to output a structured, highly precise global lane graph representing highway lane boundaries.

The transformer-based approach of the disclosure constructs a precise and coherent global lane graph for very large swaths of highways. At a high level, given top-down LiDAR intensity imagery of the highway and a coarsely annotated basemap of road centerlines, the model traverses the highway imagery in a sliding window manner using the basemap and iteratively constructs a very precise global lane graph. The lane graph construction at each traversal step may be a two-step process: First, given imagery for a local region and a prior predicted lane graph from the previous steps, the coarse model (525) outputs a coarse representation of the lane graph for the current region that extends the prior lane graph. Next, a refinement model (529) refines the coarse lane graph to be very precise and connect with the prior lane graph. The process is repeated until a globally consistent lane graph (e.g., the lane graph (551)) is obtained for the imagery of a roadway.

Problems addressed by the disclosure may be formulated as discussed herein. Suppose imagery of the highway, denoted by I, is available on top of which a very precise lane graph is to be annotated. The imagery is created by aggregating LiDAR data from multiple passes of a mapping vehicle, registering them in a 3D global coordinate frame, removing dynamic objects using a 3D segmentation model, and finally rasterizing the LiDAR intensity values in a top-down view in a global frame. Furthermore, a basemap that specifies the highway area to be mapped is available. The basemap comprises approximate road centerlines and approximate road section widths for the main highway corridor and the on/off-ramp roads. Each side of the highway has its own road centerline. The basemap may be obtained from a database or annotated quickly on the imagery without high precision.

Specified by (ξₖ)⊂ [symbol] (2) is an ordered set of poses sampled on the basemap road centerlines and specified by (Iₖ)⊂I is a set of H×W images centered and aligned with ξₖ corresponding to local regions of the highway. The imagery may have resolution of 2.5 centimeters (cm) per pixel to enable precision lane graph construction. The poses ξₖ are sampled such that Iₖ are aligned with the road and each pair of consecutive images have an approximate overlap of 20%. The poses may first traverse the main highway corridor and then go through each one of the on-ramps and off-ramps of the main highway corridor in a sliding window fashion. Each side of the highway may include a list of poses operated upon independently.

The output space of the problem is a global lane graph (551), denoted as [symbol] , where each node of the graph corresponds to a lane boundary polyline and the graph edges specify successor/predecessor relationships between the lane boundaries. Each lane boundary polyline has the same direction as the road. The edges are defined in accordance with the following. If a lane boundary changes markings, a new node is spawned. At areas of changes of topology such as forks or merges, a lane boundary node will have two successor or two predecessor nodes respectively. Moreover, a lane boundary may have zero successor nodes when terminating. [symbol] resides in the same global coordinate frame as the imagery [symbol] . For inference, the model (500) may traverse the basemap (i.e., the image (501)) in a sliding window manner through the poses ξₖ and operate on top of the imagery (Iₖ) to build the global lane graph [symbol] (551) in an incremental coarse-to-fine manner.

Turning to FIG. 6, the model (600) may implement an example of the models of the lane detection system (300) of FIG. 3. The model (600) includes the extraction model (611), the course model (631), and the refinement model (661) to processes the image (605) in multiple steps. For a current step, the pose (607) may be cropped from the image (605) to generate the lane image (609) that is input to the extraction model (611). The extraction model (611) may down sample the image (609) to the down sampled image (613), which is processed with the models (615). The models (615) may include a residual network and a feature pyramid network that output the features (617), which are suitable for the transformer decoder (639). The prior lane graph (621) may be for a prior pose from the image (605), aligned with the down sampled image (613), and input to the model (633) of the coarse model (631).

The coarse model (631) includes the model (633), which may be a multilayer perceptron that generates the prior boundary embeddings (635) from the prior lane graph (621). The prior boundary embeddings (635) and the current boundary embeddings (637) may be input to the context window of the transformer decoder (639). The transformer decoder (639) may apply cross attention between the features (617) and the boundary embeddings (635) and (637) to generate the output boundary embeddings (641) and (643). The output embeddings (641) correspond to the prior lane graph (621). The output embedding (643) may be further processed using the model (645) (may include multiple multilayer perceptrons) to generate the existence data (647), the classification data (649), the coarse lane graph (651), which corresponds to the lanes in the image (609).

The refinement model (661) processes several inputs to generate the features (663). The features (663) may include an up sampled version of the image (609), a densified version of the lane Graph (651), and features (617). The features (663) may be sampled based on the densified points from the coarse lane graph (651) to generate the point samples (665). The point samples (665) are processed with the model (667) (which may be a residual network) to generate the point embeddings (659). One of the point embeddings (669) may be generated for one of the point samples (665). The point embeddings (669) may be concatenated with corresponding boundary embeddings (641) and (643) to generate combined embeddings that form the tokens for the context window of the transformer encoder (675). The transformer encoder (675) processes the combined embeddings to generate output embeddings that are input to the model (677). The model (677) may be multiple multilayer perceptrons that generate offset and connectivity data to form the refined lane graph (691) from the prior lane graph (621) and the coarse lane graph (683). The refined lane graph (691) may correspond to the up sampled image (685), which corresponds to the image (609).

The extraction model (611), the course model (631), and the refinement model (661) form part of a network architecture as part of a system that extracts down sampled features from the imagery at each traversal step. In the coarse stage (i.e., in the coarse model (631)), learned queries and queries from the previously predicted lane graph are passed into the transformer decoder (639) to obtain coarse lane boundaries in the coarse lane graph (651). Then in the refinement and connectivity stage (i.e., in the refinement model (661)), the lane boundaries are densified into points, and local full resolution image features are gathered around each point to form the point samples (665). The point embeddings (669) generated from the point samples (665) are concatenated with the corresponding lane boundary features from the coarse stage and passed into the transformer encoder (675) to predict refinement offsets for each point and connectivity relationships between lane boundaries.

At step k of the basemap traversal, the image Iₖ (i.e., the image (609)) is first down sampled to a low resolution and passed through a residual network feature pyramid network (ResNet-FPN) backbone to create a high dimensional image feature Fₖ. Iₖ is down sampled to obtain a coarse lane graph. At step k, a partial lane graph [symbol] ₖ₋₁ may have already been predicted from previous traversal steps. The transformer decoder (639) (which may be a detection transformer (DETR)) attends to the image features Fₖ and the prior predicted lane graph [symbol] ₖ₋₁ and outputs a coarse representation [symbol] ₖ^{coarse} of the lane graph at step k, i.e. the lane boundaries may be represented with a line and are not merged with the prior lane graph [symbol] ₖ₋₁ or within themselves at areas of lane marking changes or at forks and merges.

After obtaining the coarse representation (i.e., the coarse lane graph (651)), a refinement stage is performed with the refinement model (661). Each lane boundary line from [symbol] ₖ^{coarse} is densified. Next, for each densified node of the lane boundary, a feature is created from the high-resolution imagery Iₖ, from coarse resolution FPN output FR, from decoder outputs of the first stage, and from custom query embeddings that specify whether the nodes are endpoints or not. The features from each of the nodes are passed as input to a transformer module (e.g., the transformer encoder (675)) to output a refinement offset for each node and to predict whether two lane boundary endpoints should connect. The output of this stage is a refined lane graph [symbol] ₖ for step k.

The extraction model (611) may be referred to as a feature network. The feature network may obtain dense high dimensional features for the lane graph to supply to the coarse lane graph transformer. The coarse lane graph may not be high precision and may be obtained on top of lower resolution imagery to save compute resources. As such, at step k of the traversal, the imagery Iₖ is first down sampled by a factor (e.g., of 8) to obtain a low image resolution (e.g., 20 cm/px). The down sampled image may correspond to an area (e.g., 32 m×32 m). Different factors and resolutions may be used. Since in the traversal algorithm the lane graph is obtained for each side of the highway independently, the approximate road widths of the basemap (e.g., the image (605)) may be used to mask out pixels outside of the current side to specify the mapping area of interest. The down sampled image (613) is then fed to a neural network (e.g., ResNet18 and an FPN), which outputs feature maps FR. From this feature map two auxiliary features are predicted that were found beneficial in guiding the model on the position and the class of the lane boundaries: an inverse threshold distance transform function to the nearest lane boundary, and a dilated lane marking type segmentation mask. These two features are passed through a 1×1 convolution and concatenated with the original feature map. The final feature map, denoted as Fₖ′ (e.g., the features (617)) will encode high dimensional information about the coarse position of the lane boundaries and the lane marking types. In practice, to avoid boundary effects, the feature network is run on a specified region (e.g., 51.2 m×51.2 m) and center crop the output features to another region (e.g., 32 m×32 m). Fₖ′ may be used in cross attention by the coarse lane graph decoder transformer (639) presented in the next section. Sinusoidal positional encodings may be added to Fₖ′ to encode positional information in the features.

The coarse model (631) may operate using a transformer-based model. The coarse lane graph [symbol] ₖ^{coarse} (651) is obtained through the transformer decoder (639) (which may be a detection transformer (DETR)) that attends to [symbol] ₖ₋₁ and to the features Fₖ′. The prior lane graph [symbol] ₖ₋₁ may span many kilometers. In practice, [symbol] ₖ₋₁ may be clipped to lie within a buffer around Iₖ since a shorter context will suffice for the model to extend the lane graph at step k.

Following the transformer decoder (639), M query embeddings are used for candidate new lane boundaries in [symbol] ₖ^{coarse}. The decoder also attends to the prior lane graph [symbol] ₖ₋₁, which is enabled by each prior lane boundary being densified and the coordinates being fed into the model (645) (which may be a multilayer perceptron) that outputs learned embeddings for each boundary. Let N be the number of such embeddings.

The M candidate lane boundary embeddings and the N prior lane boundary embeddings are input into the transformer decoder (639). The transformer decoder (639) performs cross attention with respect to Fₖ′ and outputs features (fₘ) (embeddings (643)) and (fₙ) (embeddings (641)) corresponding to the candidate and prior lane boundaries. Next, (fₘ) are fed into the model (645) (e.g., three multilayer perceptron heads) to be decoded into a probability for the existence of the candidate boundary, a classification for a marking type of the candidate boundary, and coordinates for the candidate boundary. Candidates with existence probability >0.5 are retained to construct [symbol] ₖ^{coarse} (e.g., the lane graph (651)). For the coarse representation, each lane boundary may be encoded as a line, i.e. with two endpoints to provide an approximation of the lane boundaries.

The refinement model (661) performs coarse lane graph refinement and connectivity reasoning. The coarse lane graph [symbol] ₖ^{coarse} is obtained on top of low resolution imagery and each lane boundary is represented as a coarse line with low precision. Furthermore, [symbol] ₖ^{coarse} lacks any connectivity within itself and to [symbol] ₖ₋₁. Two lane boundary segments should be connected if either, the segments are a continuation of each other from [symbol] ₖ₋₁ to the current section Iₖ, the segments meet at a change of lane marking on the road, or if the segments meet at forks and merges. The refinement model (661) may be designed to jointly refine the lane graph to be very precise and also identify connectivity as described below.

First, each lane boundary line in [symbol] ₖ₋₁ and [symbol] ₖ^{coarse} is densified to have points at equal distances (e.g., 3 m). Suppose pᵢ is such a point. Centered at pᵢ, a region of interest (ROI) (e.g., 6.4 meters wide) may be cropped from the high-resolution imagery I and the FPN features F of the coarse model backbone. Features from F are low resolution, so the features are bilinearly up sampled to match the resolution of I. The FPN features are then passed through a 1×1 convolution to reduce the number of channels to 3 and concatenated with the high-resolution imagery crops. The new feature will have high-resolution information on the location of lane boundaries as well as global features about the image from the FPN. The feature is fed through the model (667) (e.g., a basic ResNet) and then the middle feature of the final residual block is taken to obtain a single feature vector rᵢ corresponding to pᵢ. Next, rᵢ is concatenated with the coarse transformer decoder output queries, one of (fₘ) or (fₙ), of the lane boundary that pᵢ originates from to encode information about the lane boundary instance. For each pᵢ, a learnable query specifying whether the point is an endpoint or interior point of the densified polyline is also concatenated.

This feature is passed through a model (e.g., a multilayer perceptron) and summed with a positional encoding vector for the point pᵢ before being fed to the transformer encoder (675) to obtain output features sᵢ for pᵢ. The transformer encoder (675) provides a global context for all the densified pᵢ on [symbol] ₖ₋₁ and [symbol] ₖ^{coarse}.

For refinement, the transformer outputs (sᵢ) for [symbol] ₖ^{coarse} are passed to a first head of the model (677) (a first multilayer perceptron) to obtain a refinement offset for (pᵢ). To reason about the connectivity, the transformer output features sᵢ corresponding to the endpoints are passed into a second head of the model (677) (a second multilayer perceptron) to obtain latent vectors for each. Then, if the refined positions of two endpoints from different lane boundaries are within a threshold distance (e.g., 3 m), the corresponding latent vectors are concatenated and passed through another head of the model (677) (a third multilayer perceptron) to predict a probability that the endpoints are connected. Connectivity is made a transitive relationship to connect more than two endpoints. After processing all pairs of endpoints, if a group of endpoints are deemed connected, the endpoints are replaced with the average of their refined coordinates. The final output of this stage is a refined and connected lane graph [symbol] ₖ.

The model 600 may be trained in a two-stage process where the coarse lane graph module (the coarse model (631)) is first pre-trained. Then the full model (e.g., a combination of one or more of the extraction model (611), the coarse model (631), and the refinement model (661)) may be trained jointly.

For the coarse lane graph stage (i.e., for the coarse model (631), the Hungarian algorithm may be used. The Hungarian algorithms may match the lane boundary candidates with either a ground truth lane boundary or no object.

Denote [symbol] ₁ (P, Q) as the average [symbol] ₁ distance between the endpoints of coarse lane boundary candidate P and the endpoints of ground truth lane boundary Q. Denote p_{E}(P) as the probability that P exists. The matching cost is then described in equation 1, where c₁, c₂>0.

$$cost ( P , Q ) = {c}_{1} {ℓ}_{1} ( P , Q ) - {c}_{2} {p}_{E} ( P ) \qquad Eq . 1$$

For each prediction P, denote [symbol] _{P} as the indicator variable that P was matched successfully, and suppose Q* is the matched ground truth. Also, denote CE(P, Q) as the cross-entropy loss between the predicted lane marking classifications for P and Q. Then the loss for each prediction P is shown below, where c₁, c₂, c₃>0:

$$Loss ( P ) = {c}_{1} Focal ( {p}_{E} ( P ) , {P}_{} ) + {c}_{2} {P}_{} \cdot CE ( P , {Q}^{*} ) + {c}_{3} {P}_{} \cdot {ℓ}_{1} ( P , {Q}^{*} ) \qquad Eq . 2$$

A smooth- [symbol] ₁ loss is also applied to the outputted inverse threshold distance transform, and a cross-entropy loss to the lane marking segmentation.

For the refinement and connectivity stage, the matchings found from the coarse loss are reused and the matched ground truth lane boundary is interpolated to have the same number of points as the densified refined lane boundary. Then smooth- [symbol] ₁ loss is applied between the refined points of the prediction and the interpolated ground truth (GT) lane boundary. Connectivity may be supervised with a focal loss on whether two endpoints should be connected or not.

As an example, models in accordance with the disclosure may be trained with 2 transformer decoder layers in the coarse detector and 2 transformer encoder layers in the refinement module. Different numbers of layers may be used.

A metric called the lane graph metric (LGM) may be used as the loss function for training the model (600). The lane graph metric measures the similarity of a predicted lane graph [symbol] with polylines (Pᵢ) and a ground truth lane graph [symbol] with polylines (Qⱼ) simultaneously in terms of detection quality, topological correctness and classification. First, the polylines are densified to have points at very small intervals (e.g., 20 cm). Next, each point p is projected to the polylines of the other type (i.e. either [symbol] or [symbol] ) and assigned to be either true positive (TP), false positive (FP), or false negative (FN) corresponding to whether the projection distance is less than a threshold α. A TP indicates that p is assigned to and explains a small section of at least one polyline of the other type at threshold α whereas FP and FN indicate that p is unassigned. The detection score at threshold α is defined to be:

$$D E {T}_{α} = \frac{\vert TP \vert}{\vert TP \vert + 2 \vert FP \vert + 2 \vert FN \vert} \qquad Eq . 3$$

which is the Jaccard index. Note that FP and FN are multiplied by 2 since TP are effectively counted twice as they could belong to either a predicted or ground truth polyline. DET_{α} measures the overall alignment quality of [symbol] with respect to [symbol] but does not account for topological errors such as: a section of a polyline being assigned to multiple polylines of the other type, a polyline being fragmented, or a polyline zig-zagging between two other polylines. To measure this, an association score is created for each TP. Suppose c is a point on P∈(Pᵢ) which is a TP with respect to Q∈(Qⱼ). Let TPA(c, Q) count the number of TPs shared betwen P and Q, FPA(c, Q) count the number of FPs of P with respect to Q, and FNA(c, Q) count the number of FNs of Q with respect to P. Symmetric definitions apply if c was a TP on Q. Now, let:

$${A}_{α} ( c , Q ) = \frac{T P A ( c , Q )}{T P A ( c , Q ) + 2 F P A ( c , Q ) + 2 F N A ( c , Q )} \qquad Eq . 4$$

A_{α}(c, Q) is a Jaccard index that measures the overall alignment of P and Q anchored at c. Finally,

$${A}_{α} ( c ) = {A}_{α} ( c , {Q}^{*} ) with {Q}^{*} = {arg max}_{Q} {A}_{α} ( c , Q )$$

is defined to measure the maximum alignment score of c. A TP c could be associated to multiple nearby polylines. To penalize multiple associations the following is defined:

$${M}_{α} ( c ) = \frac{min \{ \vert nearby {P}_{i} \vert , \vert nearby {Q}_{j} \vert \}}{\vert nearby {Q}_{j} \vert} \qquad Eq . 5$$

M_{α}(c) would be 1 only if there are equal number of polylines of each type within an a radius of c and less than 1 if there are different number of polyline of each type. Finally, the topology score is defined as:

$$T O {P}_{α} = \frac{1}{\vert TP \vert} {\sum }_{c ∈ T P} {A}_{α} ( c ) {M}_{α} ( c ) \qquad Eq . 6$$

In a similar vein, a classification score is defined as:

$$C {L}_{α} = \frac{1}{\vert TP \vert} {\sum }_{c ∈ T P} 1 ( class ( P \vert c ∈ P ) = class ( {Q}^{*} ) ) \qquad Eq . 7$$

which assigns a score of 1 if the class of the parent polyline P of c is the same as that of Q*, the lane boundary in Q that maximizes the association score. Having defined detection, topology and classification scores, the LGM at a threshold α is the geometric mean of the three:

$$L G {M}_{α} = \sqrt[3]{{DET}_{α} \cdot {TOP}_{α} \cdot {CL}_{α}} \qquad Eq . 8$$

Turning to FIG. 7, three examples are shown of the high quality lane graphs that may be automatically generated for long stretches of roadways. The predicted lane graphs (705), (725), and (755), match to the ground truth graphs (708), (728), and (758). Each example is approximately 2 kilometers wide. These examples show the improvement the model provides for producing highly accurate lane graphs on large regions, as the predictions are generally indistinguishable from ground truth. Lane graph construction at scale, the method may be applied to map very large continuous lengths of highway, with inference on larger stretches of highway. Methods in accordance with the disclosure may perform continuous inference with high efficacy on regions at least as large as 12 km long without a drop in LGM. Differences between the measured metrics may be attributed to the slight changes in the exact sliding window poses used in the traversal.

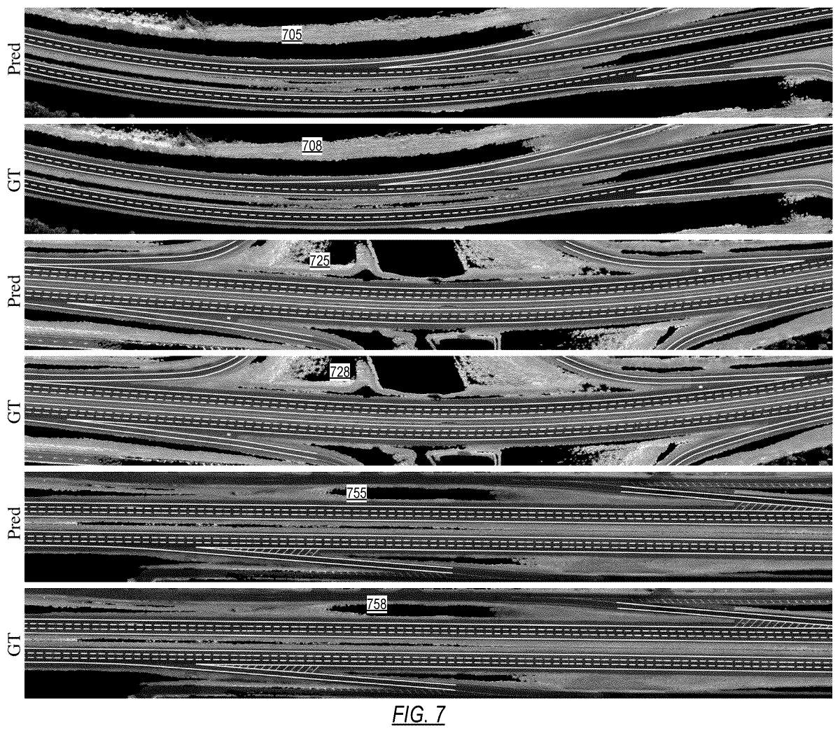

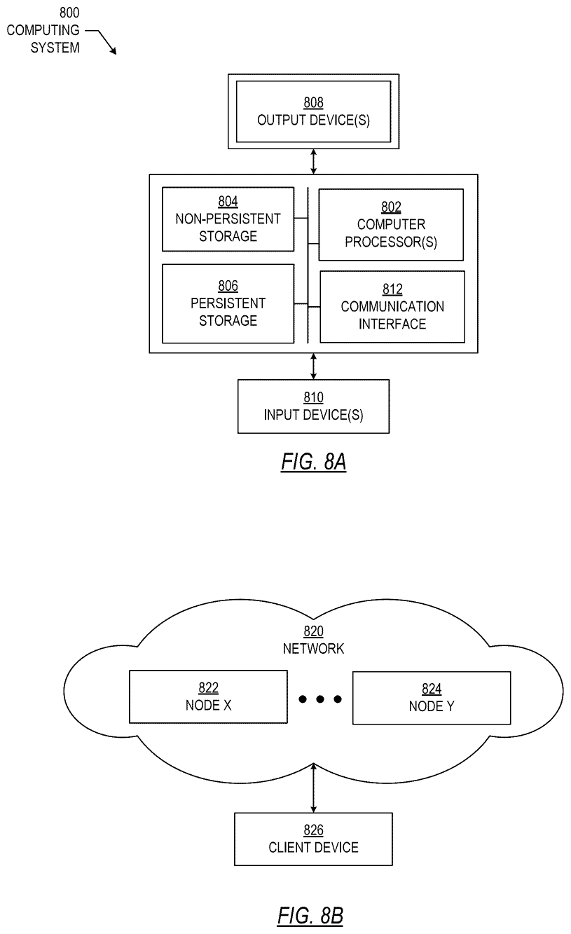

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 8A, the computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing units (TPU), combinations thereof, etc.

The input devices (810) may include a touchscreen, keyboard, mouse, microphone, touchpad, electronic pen, or any other type of input device. The input devices (810) may receive inputs from a user that are responsive to data and messages presented by the output devices (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the output devices (808) may include a display device, a printer, external storage, or any other output device. One or more of the output devices may be the same or different from the input device(s). The input and output device(s) may be locally or remotely connected to the computer processor(s) (802). Many different types of computing systems exist, and the aforementioned input and output device(s) may take other forms. The output devices (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8A. Further, the client device (826) may include and/or perform all or a portion of one or more embodiments.

The computing system of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
executing an extraction model to generate a plurality of lane features from a lane image;
executing a coarse model to generate a plurality of coarse boundary embeddings and a coarse lane graph from the plurality of lane features and a plurality of prior boundary embeddings using a transformer decoder, wherein the plurality of prior boundary embeddings is generated from a prior lane graph; and
executing a refinement model to update the prior lane graph with a refined lane graph to form an updated lane graph, wherein the refined lane graph is generated from a plurality of refined boundary embeddings that is output from a transformer encoder, wherein the transformer encoder generates the plurality of refined boundary embeddings from the plurality of coarse boundary embeddings combined with a plurality of point embeddings corresponding to the plurality of coarse boundary embeddings.

2. The method of claim 1, further comprising:
loading the refined lane graph to an autonomous system,
wherein the autonomous system executes a set of maneuvers to remain in a lane identified by the refined lane graph, and
wherein the refined lane graph comprises a node corresponding to a point of a boundary of a lane identified from the lane image and an edge corresponding to a relationship between the node and a different node.

3. The method of claim 1, wherein executing the extraction model further comprises:
down sampling the lane image to generate a down sampled image; and
executing a set of feature extraction models to generate the plurality of lane features from the down sampled image,
wherein the set of feature extraction models includes a residual network model and a feature pyramid network model,
wherein the plurality of lane features comprises a feature map with a set of channels, and
wherein the set of channels comprises a lane marking channel to identify a plurality of lane markings within the down sampled image.

4. The method of claim 1, wherein executing the coarse model further comprises:
executing a prior graph model to generate the plurality of prior boundary embeddings from the prior lane graph, wherein the prior graph model comprises a multilayer perceptron.

5. The method of claim 1, wherein executing the coarse model further comprises:
executing the transformer decoder to generate the plurality of coarse boundary embeddings from the plurality of prior boundary embeddings using cross attention between the plurality of prior boundary embeddings and the plurality of lane features,
wherein the plurality of prior boundary embeddings is used as a plurality of query parameters by the transformer decoder, and
wherein the plurality of lane features is used as a plurality of key parameters and a plurality of value parameters by the transformer decoder.

6. The method of claim 1, wherein executing the coarse model further comprises:
executing a plurality of coarse embeddings models to generate the coarse lane graph, existence data, and classification data from the plurality of coarse boundary embeddings,
wherein the plurality of coarse boundary embeddings are a subset of decoder output embeddings that do not correspond to the plurality of prior boundary embeddings.

7. The method of claim 1, wherein executing the refinement model further comprises:
up sampling the lane image to generate an up sampled image;
densifying a plurality of lane boundaries from the coarse lane graph to form a plurality of boundary points corresponding to the plurality of lane boundaries for the lane image;
sampling from the up sampled image and from the plurality of lane features using the plurality of boundary points to generate a plurality of point samples, wherein the plurality of point samples comprises a point sample corresponding to a boundary point of the plurality of boundary points, to a lane boundary of the plurality of lane boundaries, and to a coarse boundary embedding of the plurality of coarse boundary embeddings; and
executing a point embedding model to generate the plurality of point embeddings from the plurality of point samples, wherein the plurality of point embeddings comprises a point embedding corresponding to the point sample and corresponding to the coarse boundary embedding.

8. The method of claim 1, wherein executing the refinement model further comprises:
executing the transformer encoder to generate the plurality of refined boundary embeddings from the plurality of coarse boundary embeddings combined with the plurality of point embeddings using self-attention.

9. The method of claim 1, wherein executing the refinement model further comprises:
executing a plurality of refined embeddings models to generate offset data and connectivity data, wherein the offset data and the connectivity data are combined with a plurality of boundary points to form the refined lane graph; and
executing a graph combination model to generate the updated lane graph from the prior lane graph and the refined lane graph.

10. The method of claim 1, further comprising:
training the coarse model using a loss; and
training a combination of the coarse model and the refinement model using a lane graph metric.

11. A system comprising:
at least one processor; and
an application that, when executing on the at least one processor, performs a plurality of operations comprising:
executing an extraction model to generate a plurality of lane features from a lane image,
executing a coarse model to generate a plurality of coarse boundary embeddings and a coarse lane graph from the lane features and a plurality of prior boundary embeddings using a transformer decoder, wherein the plurality of prior boundary embeddings is generated from a prior lane graph, and
executing a refinement model to update the prior lane graph with a refined lane graph to form an updated lane graph, wherein the refined lane graph is generated from a plurality of refined boundary embeddings output from a transformer encoder, wherein the transformer encoder generates the plurality of refined boundary embeddings from the plurality of coarse boundary embeddings combined with a plurality of point embeddings corresponding to the plurality of coarse boundary embeddings.

12. The system of claim 11, wherein the operations further comprise:
loading the refined lane graph to an autonomous system,
wherein the autonomous system executes a set of maneuvers to remain in a lane identified by the refined lane graph, and
wherein the refined lane graph comprises a node corresponding to a point of a boundary of a lane identified from the lane image and an edge corresponding to a relationship between the node and a different node.

13. The system of claim 11, wherein executing the extraction model further comprises:
down sampling the lane image to generate a down sampled image; and
executing a set of feature extraction models to generate the plurality of lane features from the down sampled image,
wherein the set of feature extraction models includes a residual network model and a feature pyramid network model,
wherein the lane features comprise a feature map with a set of channels, and
wherein the set of channels comprises a lane marking channel to identify lane markings within the down sampled image.

14. The system of claim 11, wherein executing the coarse model further comprises:
executing a prior graph model to generate the plurality of prior boundary embeddings from the prior lane graph, wherein the prior graph model comprises a multilayer perceptron.

15. The system of claim 11, wherein executing the coarse model further comprises:
executing the transformer decoder to generate the plurality of coarse boundary embeddings from the prior boundary embeddings using cross attention between the plurality of prior boundary embeddings and the plurality of lane features,
wherein the plurality of prior boundary embeddings is used as a plurality of query parameters by the transformer decoder, and
wherein the plurality of lane features are used as a plurality of key parameters and a plurality of value parameters by the transformer decoder.

16. The system of claim 11, wherein executing the coarse model further comprises:
executing a plurality of coarse embeddings models to generate the coarse lane graph, existence data, and classification data from the plurality of coarse boundary embeddings,
wherein the plurality of coarse boundary embeddings are a subset of decoder output embeddings that do not correspond to the plurality of prior boundary embeddings.

17. The system of claim 11, wherein executing the refinement model further comprises:
up sampling the lane image to generate an up sampled image;
densifying a plurality of lane boundaries from the coarse lane graph to form a plurality of boundary points corresponding to the plurality of lane boundaries for the lane image;
sampling from the up sampled image and from the plurality of lane features using the plurality of boundary points to generate a plurality of point samples, wherein the plurality of point samples comprises a point sample corresponding to a boundary point of the plurality of boundary points, to a lane boundary of the plurality of lane boundaries, and to a coarse boundary embedding of the plurality of coarse boundary embeddings; and
executing a point embedding model to generate a plurality of point embeddings from the plurality of point samples, wherein the plurality of point embeddings comprises a point embedding corresponding to the point sample and corresponding to the coarse boundary embedding.

18. The system of claim 11, wherein executing the refinement model further comprises:
executing the transformer encoder to generate the refined a plurality of boundary embeddings from the plurality of coarse boundary embeddings combined with a plurality of point embeddings using self-attention.

19. The system of claim 11, wherein executing the refinement model further comprises:
executing a plurality of refined embeddings models to generate offset data and connectivity data, wherein the offset data and the connectivity data are combined with a plurality of boundary points to form the refined lane graph; and
executing a graph combination model to generate the updated lane graph from the prior lane graph and the refined lane graph.

20. A non-transitory computer readable medium comprising instructions executable by at least one processor to perform operations comprising:
executing an extraction model to generate lane features from a lane image;
executing a coarse model to generate a plurality of coarse boundary embeddings and a coarse lane graph from the plurality of lane features and a plurality of prior boundary embeddings using a transformer decoder, wherein the plurality of prior boundary embeddings is generated from a prior lane graph; and
executing a refinement model to update the prior lane graph with a refined lane graph to form an updated lane graph, wherein the refined lane graph is generated from a plurality of refined boundary embeddings output from a transformer encoder, wherein the transformer encoder generates the plurality of refined boundary embeddings from the plurality of coarse boundary embeddings combined with a plurality of point embeddings corresponding to the plurality of coarse boundary embeddings.
